(19) United States
(12) Patent Application Publication
(10) Pub. No.: US 2025/0057197 A1
(43) Pub. Date: Feb. 20, 2025

(54) FISH MEAL AND ITS PRODUCTION AND USE

(71) Applicant: TripleNine Group A/S, Esbjerg (DK)

(72) Inventor: Henrik Sørensen, Grinsted (DK)

(21) Appl. No.: 18/721,052

(22) PCT Filed: Dec. 5, 2022
(86) PCT No.: PCT/EP2022/084376

§ 371 Date: Jun. 17, 2024

(30) Foreign Application Priority Data
Dec. 17, 2021 (NO) 20211541

(51) Int. Cl. A23L 17/10; A22C 25/00; A23K 10/22; A23K 30/20; A23K 50/80

(52) U.S. Cl. CPC A23L 17/10; A22C 25/00; A23K 10/22; A23K 30/20; A23K 50/80

(57) ABSTRACT

The invention relates to fish meal comprising at least 74% by weight of protein, up to 10% by weight of ash and up to 1.5% by weight of phosphorous. The invention further relates to use of the fish meal as a feed for fish, shrimp, cats, dogs, pigs and poultry. The invention further relates to feed for fish and shrimp comprising the fish meal. The invention further relates to a process for producing a fish meal which comprises:
(lxxxvi) providing a fish composition comprising raw fish meat and bones, and optionally skin and/or fins;
(lxxxvii) subjecting the fish composition to mechanical separation which comprises squeezing soft components of the fish composition through perforations of a perforated drum to obtain a fraction enriched in raw fish meat, whereas a fraction enriched in fish bones, and optionally skin and/or fins remain outside of the drum,
(lxxxviii) subjecting the fraction enriched in raw fish meat to cooking, then drying, and optionally grinding.

The invention further relates to a process of treating a raw fish composition to increase its content of protein, reduce its content of ash and/or reduce its content of phosphorous, wherein the process comprises:
(lxxxvi) providing a fish composition comprising raw fish meat and bones, and optionally skin and/or fins; and
(lxxxvii) subjecting the fish composition to mechanical separation to separate the fish bones, and optionally skin and/or fins from the raw fish meat which comprises squeezing soft components of the fish composition through perforations of a perforated drum to obtain a fraction enriched in raw fish meat.

### FIELD OF THE INVENTION

The present invention relates to a fish meal and the production and use thereof. More specifically, the invention relates to a fish meal having a low content of ash and phosphorous and a high content of protein.

### BACKGROUND OF THE INVENTION

Fish meal is usually made from whole fish usually not used in human consumption or from by-products of trimmings and/or offal left over from fish caught by fisheries for human consumption. It is commonly manufactured by the steps of cooking, pressing or decanting, drying and optionally grinding of fish and/or fish waste into a solid. Fish meal is generally used to feed farm animals in an agricultural/aquacultural setting, e.g., pigs, poultry and farmed fish, the majority of fish meal being used as a feed for farmed fish. When analyzing the composition of fish meal, it varies by species and whole fish typically contains 64-74% by weight protein, 11-20% by weight of ash, 8-12% by weight of fat, 6-8% by weight of water, and 2-3% by weight of phosphorous, cf. Glencross B. D., “Unravelling Fishmeal, A Review of the Quality Assessment of Fishmeals”, Institute of Aquaculture, University of Stirling, FK9 4LA, Stirling, United Kingdom. Fishmeal produced from trimmings typically contain higher amounts of ash and lower protein than fishmeal produced from whole fish.

Ash is not considered particularly valuable for fish feed as it does not provide energy for growth. In addition, this is because the ash is composed of minerals which are not well-retained by the fish. A large component of the bones is regarded as ash, which is dominated by phosphorous and calcium. Phosphorous is bound to calcium in a form of insoluble hydroxyapatite, which is poorly digested by fish. As a result, the majority of phosphorous will be excreted by the fish, which is undesirable for the environment. Furthermore, fish need digestible phosphorous to grow, particularly in the larval and juvenile stages.

Fish bone protein also has poor digestibility for fish as it is commonly bound in a mineralized collagen matrix, resulting in increased excretion of nitrogen. This is undesirable, and the fish need an available, balanced amino acid profile to grow properly. In addition, phosphorous and nitrogen excretion are both detrimental to the environment, causing eutrophication in the water, and also has a negative impact on recirculation farms. Reducing both phosphorous and nitrogen excretion may result in increasing the biomass of fish that recirculation biofilters can handle. Examples of fish meals known in the art include those disclosed by Dutch Garden Food Service, cf. https://www.dutchgardenfoodservices.com/product.php?id=79.

It would be desirable to provide an improved fish meal having a lower content of ash, a lower content of poorly digestible phosphorous and/or a lower content of poorly digestible proteins. It would also be desirable to provide an improved fish meal which results in less negative impact on the environment, less eutrophication in water, less negative impact on fish farms with recirculation of water and/or recirculation biofilters.

### SUMMARY OF THE INVENTION

It is an object of the present invention to provide a fish meal having a low content of ash, poorly digestible phosphorous and/or poorly digestible proteins. More specifically, it is an object of the present invention to provide a fish meal having a high content of protein and a low content of ash and phosphorous, a process for producing the fish meal, and various uses for the fish meal.

By using the fish meal according to the invention, it is possible to obtain a lower content of insoluble phosphorous and phosphate containing compounds, which are poorly digested by fish, and/or to obtain a higher proportion of soluble phosphorous and phosphate containing compounds, which are more easily retained by the fish. It is also possible to add to the feed inorganic phosphate salts which are more easily retained by the fish.

In addition, by using the fish meal according to the invention, it is also possible to obtain a higher content of protein, which is advantageous as the fish need protein to grow, and thereby achieve better growth conditions for the fish. This is also advantageous when using the fish meal as a feed for other farm animals, e.g. pigs and poultry.

Further, according to the present invention, it is possible to provide fish meal with less negative impact on the environment, less eutrophication in water, and less negative impact on fish farms with recirculation of water that need both reduced nitrogen and phosphorous waste to reduce pressure on bio-filter, which allows for a higher density of fish and a healthier system.

Further benefits associated with the present invention include the following:
the fish meal is suitable for use in fish farms that need reduced phosphorous in feed due to environmental regulations;
the fish meal is suitable for feed used in fish farms where highly digestible phosphorous salts are added;
the fish meal provides improved protein digestibility;
the fish meal provides improved phosphorous digestibility;
the fish meal is suitable for feed used in farms of fish or shrimp that need a nutrient dense feed with increased protein content by means of ash reduction, such as fry or grower feed for non-salmonid carnivores such as halibut or kingfish;
the fish meal is suitable for use in pet food where a reduced amount of ash and minerals is beneficial, e.g. cat renal diets;
the fish meal may be provided as a non-hydrolyzed fish concentrate;
the fish meal has suitably not been subjected to enzymes for hydrolyzation of proteins;
the fish meal has suitably not been subjected to chemicals or organic solvents to change the composition of the fish meal;
the fish meal can be provided as a solid product, thereby simplifying the handling of the product; and
the process makes it possible to remove poorly digestible mineral-bound collagen.

Hereby the present invention provides significant technical, environmental and economic benefits.

Accordingly, in one aspect, the present invention relates to a fish meal comprising at least 74% by weight of protein, up to 10% by weight of ash and up to 1.5% by weight of phosphorous.

In another aspect, the present invention relates to the use of the fish meal according to the invention as a feed for fish, shrimp, cats, dogs, pigs and poultry, preferably for fish and shrimp.

In another aspect, the present invention relates to a feed for fish and shrimp comprising the fish meal according to the invention.

In another aspect, the present invention relates to a process of producing a fish feed comprising mixing ingredients comprising the fish meal of the invention in a mixer, extruding or pressing pellets of the ingredients, and optionally coating the pellets.

In another aspect, the present invention relates to a process for producing a fish meal which comprises:
providing a fish composition comprising raw fish meat and bones, and optionally skin and/or fins;
subjecting the fish composition to mechanical separation to obtain a fraction enriched in raw fish meat and a fraction enriched in fish bones, and optionally skin and/or fins,
subjecting the fraction enriched in raw fish meat to water removal.

In another aspect, the present invention relates to a process for producing a fish meal which comprises:
providing a fish composition comprising raw fish meat and bones, and optionally skin and/or fins;
subjecting the fish composition to mechanical separation which comprises squeezing soft components of the fish composition through perforations of a perforated drum to obtain a fraction enriched in raw fish meat, whereas a fraction enriched in fish bones, and optionally skin and/or fins remain outside of the drum,
subjecting the fraction enriched in raw fish meat to cooking, then drying, and optionally grinding.

In another aspect, the present invention relates to a process of treating a raw fish composition to increase its content of protein, reduce its content of ash and/or reduce its content of phosphorous, wherein the process comprises:
providing a fish composition comprising raw fish meat and bones, and optionally skin and/or fins; and
subjecting the fish composition to mechanical separation to separate the fish bones, and optionally skin and/or fins from the raw fish meat.

In another aspect, the present invention relates to a process of treating a raw fish composition to increase its content of protein, reduce its content of ash and/or reduce its content of phosphorous, wherein the process comprises:
providing a fish composition comprising raw fish meat and bones, and optionally skin and/or fins; and
subjecting the fish composition to mechanical separation to separate the fish bones, and optionally skin and/or fins from the raw fish meat which comprises squeezing soft components of the fish composition through perforations of a perforated drum to obtain a fraction enriched in raw fish meat.

A benefit associated with the process of the present invention is that the separation of bones, and optionally skin and/or fins, results in a fraction enriched in raw fish meat which, after being subjected to cooking, drying, and optionally grinding, provides a fish meal having a reduced amount of ash, poorly digestible phosphorous and poorly digestible protein, thus a high content of protein. Thus, the process of the invention enables production of a fish meal at a higher content of protein, a lower content of ash and/or a lower content of phosphorous.

These and other objects and aspects of the invention will be described in further detail hereinafter.

### BRIEF DESCRIPTION OF THE DRAWING

FIG. 1 is a schematic illustration of the process of the invention as carried out in the examples of the present application.

### DETAILED DESCRIPTION OF THE INVENTION

The present invention relates to a fish meal, products and compositions comprising the fish meal, as well as the production and uses thereof. The term “fish meal”, as used herein, means meal that is made from and/or based on fish and/or fish waste and/or fish bycatch and/or fish by-products of trimmings and/or offal left over from fish.

The fish meal according to the invention has a content of protein of at least 74% by weight. Preferably, the fish meal comprises at least 74% by weight of protein, at least 75% by weight of protein, or at least 76% by weight of protein, and preferably the fish meal comprises up to 85% by weight of protein, up to 83% by weight of protein, up to 80% by weight of protein, or up to 78% by weight of protein. The content of protein, in percent by weight, can be determined by the Dumas or Kjeldahl method, see for example the links: https://en.wikipedia.org/wiki/Dumas_method, https://en.wikipedia.org/wiki/Kjeldahl_method.

The fish meal according to the invention has a content of ash of up to 10% by weight. Preferably, the fish meal comprises at least 3% by weight of ash, at least 4% by weight of ash, or at least 5% by weight of ash, and preferably the fish meal comprises up to 10% by weight of ash, up to 9% by weight of ash, or up to 8% by weight of ash. The content of ash, in percent by weight, can be determined by incineration with furnace and gravimetrical analysis, see for example the link: https://www.foodscience-avenue.com/2008/05/what-is-ash-content.html.

The fish meal according to the invention has a content of phosphorous of up to 1.5% by weight. Preferably, the fish meal comprises at least 0.5% by weight of phosphorous, at least 0.7% by weight of phosphorous, at least 0.9% by weight of phosphorous, or at least 1.0% by weight of phosphorous, and preferably the fish meal comprises up to 1.5% by weight of phosphorous, up to 1.3% by weight of phosphorous, up to 1.2% by weight of phosphorous, up to 1.1% by weight of phosphorous, or up 1.0% by weight of phosphorous. The content of phosphorous, in percent by weight, can be determined by inductively coupled plasma optical emission spectrometry (ICP-OES), also referred to as ICP atomic emission spectroscopy (ICP-AES), see for example the link:
https://en.wikipedia.org/wiki/inductively_coupled_plasma_atomic_emission_s pectroscopy.

The fish meal according to the invention may also comprise fat, and usually it contains at least 3% by weight of fat. Preferably, the fish meal contains at least 4% by weight of fat, at least 5% by weight of fat, or at least 6% by weight of fat, and preferably the fish meal comprises up to 12% by weight of fat, up to 11% by weight of fat, up to 10% by weight of fat, or up to 9% by weight of fat. The content of fat, in percent by weight, can be determined by acid hydrolysis, ISO 8262-1, see for example the link:
https://www.gerhardt.de/fileadmin/Redaktion/downloads/Validation_Study_HY DROTHERM_ISO_8262-1_AOAC_922.06_english.pdf.

The fish meal according to the invention may comprise water, and usually it comprises at least 3% by weight of water. Preferably, the fish meal comprises at least 4% by weight of water, or at least 5% by weight of water, and preferably the fish meal comprises up to 12% by weight of water, up to 11% by weight of water, up to 10% by weight of water, or up to 9% by weight of water. The content of water, in percent by weight, can be determined by gravimetric analysis, cf. the link:
https://en.wikipedia.org/wiki/Gravimetric_analysis.

The present invention also relates to the use of the fish meal according to the invention as a feed for fish, shrimp, cats, dogs, pigs and poultry, preferably for fish and shrimp.

The present invention also relates to a feed for fish and shrimp, herein also referred to as “the fish feed”, comprising the fish meal according to the invention. The fish feed may be in the form of pellets. Such pellets contain the fish meal of the invention and may also contain plant-based ingredients, e.g. soya, wheat, pea, rapeseed, etc., and/or animal-based ingredients, e.g. poultry meal, blood meal, etc.

The feed, fish feed and pellets according to the invention may contain up to 100% by weight of the fish meal according to the invention. Suitably, the feed, fish feed and pellets according to the invention contain at least 1% by weight, or at least 5% by weight, or at least 10% by weight of the fish meal according to the invention, and the feed, fish feed and pellets according to the invention suitably contain up to 70% by weight, or up to 50% by weight, or up to 40% by weight, or up to 30% by weight of the fish meal according to the invention.

The present invention also relates to a process of producing a fish feed comprising mixing ingredients which comprises the fish meal of the invention in a mixer, extruding or pressing pellets of the ingredients, and optionally coating the pellets, for example coating the pellets with an oil. Example of suitable ingredients for the pellets include rapeseed oil and fish oil.

The present invention also relates to a process for producing a fish meal which comprises:
providing a fish composition comprising raw fish meat and bones, and optionally skin and/or fins;
subjecting the fish composition to mechanical separation to obtain a fraction enriched in raw fish meat and a fraction enriched in fish bones, and optionally skin and/or fins,
subjecting the fraction enriched in raw fish meat to water removal.

The present invention also relates to a process of treating a raw fish composition to increase its content of protein, reduce its content of ash and/or reduce its content of phosphorous, wherein the process comprises:
providing a fish composition comprising raw fish meat and bones, and optionally skin and/or fins; and
subjecting the fish composition to mechanical separation to separate the fish bones, and optionally skin and/or fins from the raw fish meat.

In the process of the invention, the mechanical separation may be carried out by squeezing soft components of the fish composition through perforations of a perforated drum to obtain a fraction enriched in raw fish meat. Preferably, a fraction enriched in fish bones, and optionally skin and/or fins remain outside of the drum.

In the process of the invention, the water removal is suitably carried out for preservation of quality and increasing shelf life of the fraction enriched in raw fish meat. The water removal may be carried out by drying and optionally grinding, preferably by cooking, drying and optionally grinding.

The present invention also relates to a process for producing a fish meal which comprises:
providing a fish composition comprising raw fish meat and bones, and optionally skin and/or fins;
subjecting the fish composition to mechanical separation which comprises squeezing soft components of the fish composition through perforations of a perforated drum to obtain a fraction enriched in raw fish meat, whereas a fraction enriched in fish bones, and optionally skin and/or fins remain outside of the drum,
subjecting the fraction enriched in raw fish meat to cooking, then drying, and optionally grinding.

The present invention also relates to a process of treating a raw fish composition to increase its content of protein, reduce its content of ash and/or reduce its content of phosphorous, wherein the process comprises:
providing a fish composition comprising raw fish meat and bones, and optionally skin and/or fins; and
subjecting the fish composition to mechanical separation to separate the fish bones, and optionally skin and/or fins from the raw fish meat which comprises squeezing soft components of the fish composition through perforations of a perforated drum to obtain a fraction enriched in raw fish meat.

Preferably, the composition comprising the raw fish meat obtained by the process of the invention has an increased content of protein, reduced content of ash and/or reduced content of phosphorous.

Preferably, the fish meal and composition obtained by the process of the invention have a higher Apparent Digestibility Coefficient for protein and/or a higher Apparent Digestibility Coefficient for phosphorous compared to the composition used as a starting material in the process. Usually, the Apparent Digestibility Coefficient, herein also referred to as “ADC”, for protein and/or phosphorous is at least 1% higher, suitably at least 2% higher, or at least 5% higher, and up to 15% higher, or up to 10% higher, compared to the composition used as a starting material.

The ADC of the fish meal and composition can be determined by measuring absolute masses of protein and phosphorous ingested and recovered in faeces sample of fish fed with such fish meal and composition, making use of the analytical methods referred to above for protein and phosphorous, and calculating the Apparent Digestibility Coefficient, in %, for protein and phosphorous, ADCᵢ=(Cᵢ−Fᵢ)/Cᵢ □100, where i refers to protein or phosphorous, Ci is the mass of i consumed, and F is the mass of i recovered in faeces.

Preferably, the fish meal and/or raw fish meat obtained by the process of the invention comprise protein, ash and/or phosphorous, optionally also fat and/or water, in the amounts and ranges described above for fish meal according to the invention, preferably at least 74% by weight of protein, up to 10% by weight of ash and up to 1.5% by weight of phosphorous.

The fish compositions for use in the process of the invention may comprise any raw fish in the form of fish meat and bones, and optionally skin and/or fins. Examples of suitable fish compositions include fish usually not used in human consumption, e.g. sprat, sand eel, blue whiting, pout, etc., and by-products of trimmings and/or offal left over from fish caught by fisheries for human consumption, e.g. cod, herring, whitefish, mackerel, plaice, Salmonidae, such as salmon, salmon smolt, char and trout.

In the mechanical separation of the process of the present invention, the squeezing may be made by hand or by means of a device, e.g. a drum such as a flexible drum, or a belt such as a flexible belt.

Preferably, the mechanical separation takes place in a separator, which may be a perforated drum with perforations, or holes. Preferably, in the mechanical separation, a belt, suitably a squeezing belt, preferably a flexible squeezing belt, transports the fish composition to the perforated drum and squeezes soft components of the fish composition, which comprises raw fish meat, and optionally water, through the perforation, i.e. the holes, whereas solid components of the fish composition, which comprises bones, and optionally skin and/or fins, remain outside of the drum. Preferably, the squeezing belt may apply a pressure that can be varied, and preferably the squeezing is gentle.

The belt, also referred to herein as a “flexible belt”, “squeezing belt” or a “flexible squeezing belt, may be made of any material, such as a flexible material, e.g. an elastomeric material.

The flexible drum may have a diameter that is adjustable and larger than the diameter of the perforated drum. By providing the fish composition between the perforated drum and the flexible drum, and then rotating the flexible drum in relation to the perforated drum and decreasing the diameter of the flexible drum, the fish composition is squeezed against the perforated drum and soft components are squeezed through the perforations into the perforated drum. When using a flexible drum, it is also possible to carry out the separation by providing the fish composition between the perforated drum and the flexible drum, and then rotating the perforated drum in relation to the flexible drum and decreasing the diameter of the flexible drum, whereby the fish composition is squeezed against the perforated drum and soft components are squeezed through the perforations into the perforated drum.

Preferably, the perforated drum is made by a metallic material, e.g. stainless steel. The perforated drum has perforations or holes which may have a diameter or largest cross section of not more than about 5.0 mm, preferably from 0.5 to 3.0 mm, or from 0.8 to 2.0 mm, or from 1.0 to 1.5 mm. The perforated drum may have a large number of holes, e.g. at least 1,000, or at least 5,000 or at least 10,000 holes, and the number of holes may be up to 70,000, or up to 50,000, or up to 40,000. The number of holes may depend on the diameter or largest cross section of the holes such that the smaller the diameter, the higher number of holes.

The number of perforations or holes per area of drum may depend on the drum used and the diameter or largest cross section of the holes; the perforated drum may have from 1 to 50 holes per cm², usually from 3 to 40 holes per cm², or 5 to 25 holes per cm². The number of holes per area may depend on the diameter or largest cross section of the holes such that the smaller the diameter, the higher number of holes per area. For a perforated drum having perforations or holes with a diameter or largest cross section of 1.3 mm, the number of holes per area may be from 5 to 50 holes per cm², or from 10 to 40 holes per cm², or from 15 to 25 holes per cm². For a perforated drum having perforations or holes with a diameter or largest cross section of 3.0 mm, the number of holes per area may be from 1 to 9 holes per cm², or from 2 to 8 holes per cm², or from 5 to 7 holes per cm². The number of holes and the number of holes per area may affect the throughput of the mechanical separation.

The mechanical separation preferably takes place without heating, e.g. at ambient temperature or lower, preferably at a temperature below 25° C., or from 0 to 20° C., or from 5 to 15° C.

Example of suitable separators for use in the mechanical separation of the invention include a soft separator which is commercially available under the name Baader 604, cf. the link:
https://baader.com/en/products/separator_processing/fish/index.html#baader_604_en), which is available from the Baader Group, Germany. Examples of perforated drums suitable for use in this separator include those having 39,352 holes with a diameter of 1.3 mm and about 19 holes per cm², or 12,800 holes with a diameter of 3.0 mm and about 6 holes per cm².

Compared to the starting material of the process, i.e. the fish composition, the fraction enriched in raw fish meat obtained by the mechanical separation, herein also referred to as the “meat fraction”, is depleted in bones, and optionally skin and/or fins. Similarly, the fraction enriched in bones, and optionally skin and/or fins, obtained by the mechanical separation, herein also referred to as the “bones fraction”, is depleted in raw fish meat.

The mechanical separation of the meat fraction from the bones fraction results in a meat fraction which, by the process of the invention, provides a fish meal having a reduced content of ash, poorly digestible phosphorous and poorly digestible protein. Hereby the content of both ash and phosphorous may be used as an indicator of how much of the bones, and optionally skin and/or fins, are present in the meat fraction after the mechanical separation. Preferably, the meat fraction obtained by the mechanical separation, or fish meal obtained by the process, is analysed in terms of its content of ash and phosphorous. If the content of ash and/or phosphorous is considered to be too high, the meat fraction may be subjected to repeated mechanical separation in the process, for example at least once more, to achieve a desired content of ash and phosphorous of the meat fraction and the fish meal obtained by the process. Alternatively, the process parameters may be adjusted to reduce the amount of the bones, and optionally skin and/or fins, that remains in the meat fraction after the mechanical separation. This may be made by adjusting the diameter or largest cross section of the perforations or holes and/or the number of holes of the perforated drum to achieve a desired degree of separation and/or by adjusting the pressure of the flexible belt by which the soft components of the fish composition are squeezed through the holes of the perforated drum to achieve a desired degree of separation. Further, the pressure settings of the flexible squeezing belt may be adjusted and optimized to achieve a desired balance between yield or throughput of the mechanical separation and the content of ash and phosphorous of the meat fraction. A lower yield or throughput when separating the meat fraction from the bones fraction is typically linked to a lower content of ash and phosphorous of the meat fraction.

Removing water by drying fishmeal with heat is the traditional method to preserve fish products. Preferably, the drying process reduces the water content and kills unwanted bacteria. A reduced water content may also reduce the risk of oxidation, spoiling, bacterial and mold growth. Other processes which preserve fish-based ingredients, remove water or reduce the water content of fish products may be used, e.g. freeze drying, spray drying or sileage methods, which are normally used for products with water content over 50% by weight.

Sileage methods may be used to preserve by adding one or more acids to fish meal. In order to process meals with the traditional method, which produces separate fish meal and oil products, production of low phosphorous fish protein concentrate may be performed by subjecting the raw fish meat fraction to cooking at temperatures above 70° C. in order to enable separation of oil from the solids in the next step. The cooked meat fraction may be separated into a solid and liquid fraction. The liquid fraction may then be separated into oil or stickwater fractions. The stickwater fraction may then be concentrated in an evaporator to a dry matter content of about 50% by weight. Both the concentrated stickwater and solids may be dried in a dryer.

If desired, the cooked fish is subjected to pressing whereby the cooked fish is compressed inside a perforated tube, expelling some of its liquids, resulting in a fish press cake having a reduced water content. Alternatively, a decanter may be used followed by a centrifuge to separate solids, a water fraction and oil fraction. In the pressing/decanting step, the water content may be reduced from 70 to about 50% by weight, and also the content of oil may be reduced. Water-soluble proteins in the water fraction are then typically, but not always, condensed in an evaporator before added back to the solids in the dryer.

Drying of the fish solids or press cake may take place by tumbling inside a heated drum, e.g. a cylinder containing steam-heated discs, to obtain a dried cooked fish in the form of coarse particles. This dried fish may constitute the fish meal and/or be used as the fish meal of the invention. If desired, the dried cooked fish is subjected to grinding or milling to reduce the particle size of coarse particles to achieve the fish meal and to facilitate uniform incorporation in feeds. If desired, a ground or milled fish meal is readily mixed into feed rations which require homogeneous blending. Grinding or milling of fish meal may take place by using a dry mill, e.g. a hammer mill, in which the coarse meal is disintegrated by the impact of rapidly rotating hammers, pivoted on horizontal or vertical shafts. A grating is usually attached around a rotor which retains the fish meal until it is fine enough to pass through perforations.

### EXAMPLES

The invention is further illustrated in the following examples which, however, are not intended to limit the same. Parts and % relate to parts by weight and % by weight, respectively, and all suspensions are aqueous, unless otherwise stated.

### Example 1

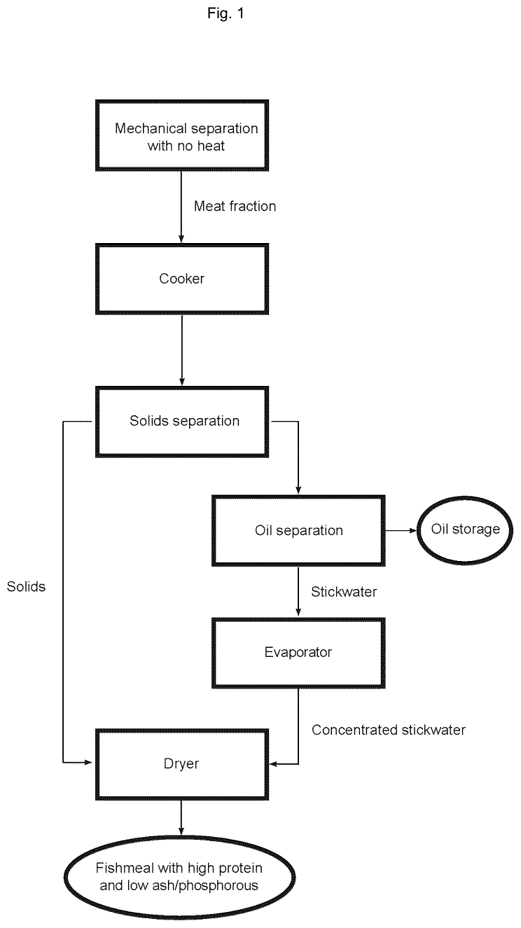

This Example illustrates the preparation of a fish meal according to the invention, which is also schematically illustrated in FIG. 1.

The fish composition used in this example was based on plaice, including raw fish, bones, optionally skin and fins.

The mechanical separation was carried out using a soft separator, Baader 604, https://baader.com/en/products/separator_processing/fish/index.html#baader_604_en, i.e., a soft separator with a stainless steel perforated drum and pressure adjustment of squeezing belt. In the example, use was made of a pressure of 20 and minimum distance of 12. The perforated drum had 39,352 holes with a diameter of 1.3 mm and approximately 19 holes per cm².

In the mechanical separation, a flexible squeezing belt transported the fish composition to the perforated drum and squeezed soft components of the fish composition, mainly raw fish meat and water, through the holes, whereas solid components of the fish composition, mainly bones, skin and fins, remained outside the drum.

The raw fish meat fraction was subjected to cooking at temperatures above 90° C. The cooked meat fraction was then pumped to a decanter where the solids was separated from the liquid. The liquid fraction was then separated into oil or stickwater fractions. The stickwater fraction was then concentrated in an evaporator to a dry matter content of 50% by weight. Both the concentrated stickwater and solids were dried in a dryer.

Fish meal obtained by the process was analysed and Table 1 shows the average results:

TABLE 1

| | | Content |
|---|---|---|
| | | (% by |
| Component | Method of Analysis | weight) |
| Protein | Dumas method | 79 |
| Ash | Incineration with furnace and | 7 |
| | gravimetrical analysis | |
| Fat | Acid hydrolysis method | 6 |
| Water | Gravimetrical analysis | 8 |
| Phosphorous | ICP-OES | 0.82 |

As is evident from Table 1, the process using a raw plaice-based fish composition resulted in a fish meal with a high content of protein and a low content of ash and phosphorous.

### Example 2

This Example provides an evaluation of fish meals and feeds made thereof in terms of protein and phosphorous digestibility.

Fish meals designated FM1 and FM2 were used in this Example. Both FM1 and FM2 were produced with North Sea fish species. FM1 is a wholemeal fish meal used for comparison. FM2 is a fish meal according to the invention which was produced by the process of the invention. The fish meals were analysed and Table 2 shows the results:

TABLE 2

| | | FM1 | FM2 |
|---|---|---|---|
| | | (% by | (% by |
| Component | Method of Analysis | weight) | weight) |
| Protein | Dumas method | 68.5 | 77.5 |
| Ash | Incineration with | 13.3 | 7.5 |
| | furnace and | | |
| | gravimetrical analysis | | |
| | method | | |
| Water | Gravimetrical analysis | 6.1 | 8.9 |
| Phosphorous | ICP-OES | 2.0 | 0.9 |

Feeds for fish and shrimp, hereinafter “fish feeds”, were produced by mixing the fish meals FM1 and FM2 with a standard plant-based protein. Finally, the fish feeds were provided in the form of 3 mm extruded pellets.

In order to evaluate protein digestibility, three fish feeds were prepared: A fish feed used as a reference diet contained 100% plant-based proteins. A fish feed used for comparison contained 70% by weight of the reference diet and 30% by weight of the fish meal FM1. A fish feed according to the invention contained 70% by weight of the reference diet and 30% by weight of the fish meal FM2 according to the invention. Thus, the only difference between the fish feeds containing fish meal was the type of fish meal used.

In order to evaluate phosphorous digestibility, the following fish feeds were provided. A fish feed used as a reference diet contained 100% plant-based proteins. A fish feed used for comparison contained 90% by weight of the reference diet and 10% by weight of the fish meal FM1. A fish feed according to the invention contained 90% by weight of the reference diet and 10% by weight of the fish meal FM2 according to the invention. Thus, also here the only difference between the fish feeds containing fish meal was the type of fish meal used.

Each fish feed was fed to triplicate tanks of Rainbow trout (Oncorhynchus mykiss, starting weight averaging 70 g) for 9 days and faeces were collected daily from the bottom of the conical tank, pooling samples from each three successive days.

Digestibility of the fish meal in terms of Apparent Digestibility Coefficient, herein also referred to as “ADC”, were determined by measuring absolute masses of protein and phosphorous ingested and recovered in faeces sample, making use of the analytical methods referred to above for protein and phosphorous, and calculating the ADC for protein and phosphorous, ADCᵢ=(Cᵢ−Fᵢ)/Cᵢ □100, where i refers to protein or phosphorous; Ci is the mass of i consumed; and F is the mass of i recovered in faeces.

The ADC for protein of the fish meal used for comparison containing FM1 was 91.4% whereas the ADC for protein of the fish meal according to the invention containing FM2 was 97.8%.

The ADC for phosphorous of the fish meal used for comparison containing FM1 was 80.0% whereas the ADC for phosphorous of the fish meal feed according to the invention containing FM2 was 99.6%.

As is evident from the results presented above, the fish meals according to the invention showed significantly higher ADC for both protein and phosphorous, thus higher protein digestibility and higher phosphorous digestibility, over the fish meals used for comparison.

1. A fish meal comprising at least 74% by weight of protein, up to 10% by weight of ash and up to 1.5% by weight of phosphorous.

2. The fish meal of claim 1, wherein it comprises at most 85% by weight of protein, preferably it comprises at least 74% by weight of protein, at least 75% by weight of protein, or at least 76% by weight of protein, and up to 85% by weight of protein, up to 83% by weight of protein, up to 80% by weight of protein, or up to 78% by weight of protein.

3. The fish meal of claim 1, wherein it comprises at least 76% by weight of protein, and preferably it comprises up to 85% by weight of protein, up to 83% by weight of protein, up to 80% by weight of protein, or up to 78% by weight of protein.

4. The fish meal of claim 1, wherein it comprises at least 3% by weight of ash, preferably it comprises at least 4% by weight of ash, or at least 5% by weight of ash, and up to 10% by weight of ash, up to 9% by weight of ash, or up to 8% by weight of ash.

5. The fish meal of claim 1, wherein it comprises at least 5% by weight of ash, and preferably it comprises up to 10% by weight of ash, up to 9% by weight of ash, or up to 8% by weight of ash.

6. The fish meal of claim 1, wherein it comprises at least 0.5% by weight of phosphorous, preferably it comprises at least 0.7% by weight of phosphorous, at least 0.9% by weight of phosphorous, or at least 1.0% by weight of phosphorous, and up to 1.5% by weight of phosphorous, up to 1.3% by weight of phosphorous, up to 1.2% by weight of phosphorous, up to 1.1% by weight of phosphorous, or up 1.0% by weight of phosphorous.

7. The fish meal of claim 1, wherein it comprises at least 3% by weight of fat, preferably at least 4% by weight of fat, at least 5% by weight of fat, or at least 6% by weight of fat, and up to 12% by weight of fat, up to 11% by weight of fat, up to 10% by weight of fat, or up to 9% by weight of fat.

8. The fish meal of claim 1, wherein it comprises at least 3% by weight of water, preferably at least 4% by weight of water, or at least 5% by weight of water, and up to 12% by weight of water, up to 11% by weight of water, up to 10% by weight of water, or up to 9% by weight of water.

9. The fish meal of claim 1, wherein it comprises up to 9% by weight of water.

10. The fish meal of claim 1, wherein it comprises at least 76% by weight of protein, at least 5% by weight of ash, and up to 9% by weight of water.

11. The fish meal claim 1, wherein it is non-hydrolyzed and/or not subjected to enzymes for hydrolyzation of proteins.

12. (canceled)

13. A feed for fish and shrimp comprising the fish meal of claim 1, wherein the feed is in the form of pellets.

14. The feed of claim 13, wherein it comprises fish meal in an amount of from 1 to 70% by weight, or from 5 to 50% by weight, or from 10 to 40% by weight.

15. A process for producing a fish meal which comprises:
(i) providing a fish composition comprising raw fish meat and bones, and optionally skin and/or fins;
(ii) subjecting the fish composition to mechanical separation which comprises squeezing soft components of the fish composition through perforations of a perforated drum to obtain a fraction enriched in raw fish meat, whereas a fraction enriched in fish bones, and optionally skin and/or fins remain outside of the drum,
(iii) subjecting the fraction enriched in raw fish meat to cooking, drying, and optionally grinding, and
(iv) obtaining a fish meal of claim 1.

16. A process of treating a raw fish composition to increase its content of protein, reduce its content of ash and/or reduce its content of phosphorous, wherein the process comprises:
(i) providing a fish composition comprising raw fish meat and bones, and optionally skin and/or fins; and
(ii) subjecting the fish composition to mechanical separation to separate the fish bones, and optionally skin and/or fins from the raw fish meat which comprises squeezing soft components of the fish composition through perforations of a perforated drum to obtain a fraction enriched in raw fish meat, preferably to reduce its content of phosphorous.

17. The process of claim 15, wherein the mechanical separation comprises squeezing soft components of the fish composition through perforations of a perforated drum by means of a belt, preferably a flexible belt, preferably the flexible belt is made of an elastomeric material.

18. The process of claim 15, wherein the mechanical separation comprises transporting the fish composition to the perforated drum by means of a belt, preferably a flexible belt, preferably the flexible belt is made of an elastomeric material.

19. The process of claim 15, wherein the perforated drum has perforations or holes having a diameter or largest cross section of not more than 5.0 mm, preferably from 0.5 to 3.0 mm, or from 0.8 to 2.0 mm, or from 1.0 to 1.5 mm, and preferably the perforated drum has from 1 to 50 perforations or holes per cm2, or from 3 to 40 perforations or holes per cm2, or 5 to 25 perforations or holes per cm2.

20. The process of claim 15, wherein the perforated drum is made of a metallic material, preferably stainless steel.

21. The process of claim 15, wherein the mechanical separation takes place at temperature of below 25° C., preferably from 0 to 20° C., preferably from 5 to 15° C.

22. The process of claim 15, wherein the fish meal or raw fish meat obtained by the process has a higher Apparent Digestibility Coefficient for protein and/or a higher Apparent Digestibility Coefficient for phosphorous compared to the composition used as a starting material in the process.
